(19) United States
(12) Patent Application Publication
(10) Pub. No.: US 2026/0362090 A1
(43) Pub. Date: Nov. 12, 2026

(54) METHOD AND SYSTEM FOR SHARING BROADCAST SOURCE INFORMATION DURING AN AUDIO BROADCAST SESSION

(71) Applicant: SAMSUNG ELECTRONICS CO., LTD., Suwon-si (KR)

(72) Inventors: Shruthi SIRUR, Bangalore (IN); Naman Kumar JAIN, Bangalore (IN); Tathagat KUMAR, Bangalore (IN)

(73) Assignee: SAMSUNG ELECTRONICS CO., LTD., Suwon-si (KR)

(21) Appl. No.: 19/737,209

(22) Filed: Jul. 10, 2026

Related U.S. Application Data
(63) Continuation of application No. PCT/KR2025/002058, filed on Feb. 12, 2025.

(30) Foreign Application Priority Data
Mar. 1, 2024 (IN) 202441015492
Dec. 4, 2024 (IN) 202441015492

(51) Int. Cl. H04W 4/06; G06F 3/16

(52) U.S. Cl. CPC H04W 4/06; G06F 3/165

(57) ABSTRACT

A method and a device for sharing broadcast source information during an audio broadcast session are provided. The method includes determining, by a sender device, whether broadcast source information associated with an audio broadcast session is to be shared with at least one receiver device based on a user input from a user of the sender device and a request from the at least one receiver device; based on determining that the broadcast source information is to be shared with the at least one receiver device, selecting, by the sender device, a transmission medium from among a plurality of transmission mediums for sharing the broadcast source information; and transmitting, by the sender device, at least one data packet over the transmission medium, the at least one data packet including the broadcast source information.

### CROSS-REFERENCE TO RELATED APPLICATIONS

This application is a by-pass continuation application of International Application No. PCT/KR2025/002058, filed on Feb. 12, 2025, which is based on and claims priority to Indian Provisional Patent Application No. 202441015492, filed on Mar. 1, 2024, and Indian Complete patent application No. 202441015492, filed on Dec. 4, 2024, in the Indian Intellectual Property Office, the disclosures of which are incorporated by reference herein their entireties.

### BACKGROUND

### 1. Field

The present disclosure relates to wireless communication, and more particularly, to a system and method for sharing broadcast source information during an audio broadcast session.

### 2. Description of Related Art

The field of audio streaming has experienced significant advancements with the emergence of Bluetooth Low Energy (BLE) audio. The BLE audio enables media streaming using both classic Bluetooth and the BLE protocols. In contrast to the classic Bluetooth, the BLE is designed for significantly lower power consumption. Low Energy (LE) audio enables new use cases including multi-stream audio, Low Complexity Communication Codec (LC3), LE audio broadcast, and personal audio sharing.

BLE broadcast has a concept of source, assistant, and sink. The assistant role is unique in the BLE broadcast. The broadcast source is the sender of data. The broadcast sink is the receiver of data. The broadcast sink is assisted by the broadcast assistant in finding and joining the broadcast source.

In Wi-Fi access point (AP) information sharing, the hotspot details and password are exchanged between the hotspot AP (Sender) and the client (Receiver). In contrast, information about broadcast source is shared between broadcast source and assistant devices, rather than directly between broadcast source (Sender and the broadcast sink (Receiver)). Wi-Fi AP information pertains to details specific to Wi-Fi technology, such as the AP name and password. On the other hand, BLE broadcast source information includes additional data, such as the quality of the audio from the source and metadata related to the broadcast, like the media player name, track title, artist, and other related information.

FIG. 1 illustrates an example scenario 100 depicting Low Energy (LE) audio broadcast Bluetooth technology for broadcasting audio, according to the related art. LE audio introduced broadcast audio to Bluetooth technology, which is a new feature that enables an audio transmitter 101 to broadcast to an unlimited number of nearby Bluetooth audio receivers (e.g., headphones, earbuds, hearing aids) 103. The broadcast audio opens significant new opportunities for innovation, including powerful new capabilities such as LE audio broadcast. An LE audio broadcast transmission starts with an LE audio broadcast that includes advertisements 105. These advertisements 105 provide key information about the broadcast, such as the name, metadata related to the audio streams 109, codec configuration, and more, as well as one or more audio streams 109 (e.g., left and right stereo audio streams). The LE audio broadcast transmitter 101 functions as the LE audio broadcast source.

Additionally, LE audio broadcast assistants 107 actively scan for these advertisements 105 and present a user interface (UI) that allows users to select which LE audio broadcast the users want to join, similar to how users select Wi-Fi networks in public spaces. Once an LE audio broadcast is chosen, the assistant 107 delivers the necessary information to the LE audio broadcast receiver 103 to join the broadcast. These receivers 103, known as LE audio broadcast audio sink devices, are also referred to as scan delegators.

In certain scenarios, a user equipment (UE) can take on the roles of both the LE audio broadcast source and the LE audio broadcast assistant, in which case it is called a collocated LE audio broadcast source and assistant. Furthermore, when a UI for selecting the LE audio broadcast source is not available, the UI offloads the scan functionality to the LE audio broadcast assistant through a role known as the LE audio broadcast scan delegator. In such instances, the LE audio broadcast sink devices take on the combined roles of LE audio broadcast scan delegator and LE audio broadcast sink.

Further, in order to join a conventional LE audio broadcast, users typically use methods like searching, scanning, or tapping. In the searching method, the users, i.e., audio broadcast sinks, use their broadcast assistant, typically a device with a user interface such as phone, tablet, watch etc., to find and join the LE audio broadcast; similar to how users search for and connect to a Wi-Fi network, for example using broadcast source 1. In the scanning method, the users scan a quick response (QR) code using their broadcast assistant, allowing them to seamlessly join the broadcast. In the tapping method, users tap an LE audio broadcast transmitter, for example using their broadcast assistant devices, much like the “tap and pay” method, to gain access to the broadcast. However, related art methods of joining a broadcast come with several pain points, especially when a group of users tries to join the same broadcast. These issues may include the following:

Duplicate broadcast names: When multiple broadcast sources have the same name, it can confuse users. For example, if several broadcasters use the name “broadcast source 1,” users may struggle to determine which is the correct source since the LE audio specification does not require unique broadcaster names.

Password sharing: If the broadcast is secured, users need to manually enter a password after finding and selecting the broadcast. This can be inconvenient and error-prone, especially in public settings.

Multiple user actions: Users must navigate through several steps-finding the broadcast, selecting it, and syncing information between their device and the broadcast source. In group scenarios, this can lead to excessive power consumption and delays as each member performs these steps.

Fixed QR code display: QR codes are typically static, meaning users need to physically move near the code to scan and join the broadcast. If the QR code is a printed display, every user must approach it, which can be inefficient in crowded or large spaces.

Fixed Near Field Communication (NFC) tap pod: Like QR codes, NFC tap pods are also stationary. The users must go near the pod to tap and join the broadcast, creating potential bottlenecks in busy environments.

Risk of joining malicious broadcasts: Malicious broadcasters can mimic the names of legitimate LE audio broadcast sources. If users accidentally connect to these sources, the users risk receiving harmful data that could damage their devices.

These issues highlight the challenges of current methods for joining LE audio broadcasts, especially in group scenarios, where efficiency, security, and ease of access are critical.

FIG. 2 illustrates a timing diagram 200 depicting the broadcasting of the audio using Broadcast Isochronous stream (BIS), according to the related art. The BIS uses connectionless isochronous channels to transmit data. In particular, the BIS does not require acknowledgments from either the users or receivers. Additionally, the robustness of the BIS is enhanced by repeating the same audio packets, which helps maximize the likelihood of successful reception at the audio receiver.

FIG. 3 illustrates an example 300 depicting periodic advertising (PA) events from the same advertising set, according to the related art. Periodic advertising is used when data needs to be sent at regular, fixed intervals. This form of advertising involves transmitting advertisements at fixed intervals, with the advertisement data occasionally changing. Periodic advertising also utilizes offloading, where an advertisement is first sent on the primary channel, pointing to an auxiliary packet located on the secondary channel. Additionally, when instructed by the host, the scanner will search for periodic advertising synchronization information found in the SyncInfo field of AUX_ADV_IND PDUs to scan for periodic advertisements.

FIG. 4 illustrates an example 400 of a Broadcast Isochronous Group (BIG) for broadcasting audio, according to the related art. The process begins when the user starts playing music, enabling the user device (referred to as the mobile) to initiate the broadcast of the music. The mobile device, which includes an assistant, displays a list of all nearby broadcast sources and allows the user to choose one. In this example, the user selects the broadcast source “ABC music,” which then initiates audio streaming through the selected broadcast.

FIG. 5 illustrates an example 500 depicting extended advertising (EA) for the BIG, according to the related art. The example 500 continues from the previous example 400, detailing how the broadcast uses primary advertising channels. Each Broadcast Isochronous Group (BIG) requires its own personalized advertising set, which includes an ADV_EXT_IND packet. Additionally, an AUX_ADV_IND is transmitted across 37 general-purpose channels, with each channel containing advertising data specific to the BIG. This data includes a broadcast audio announcement service universally unique identifier (UUID), along with other service UUIDs.

Furthermore, the AUX_SYNC_IND packet utilizes an additional controller advertising data field (ACAD) to identify BIGInfo and AdvData. This information is used to determine the basic audio announcement service UUID and the broadcast audio base, ultimately enabling the creation and transmission of the BIS.

Additionally, in line with the existing technique, the Broadcast Audio Stream Endpoint (BASE) is transmitted in a Periodic Advertising (PA) packet. The BASE is used to inform scanning devices about the codec configuration and other metadata related to a Broadcast Isochronous Group (BIG), which carries one or more broadcast audio streams.

Further, broadcast audio scan service (BASS) is a service that is initiated in an acceptor to expose the details of which broadcast audio streams the BASS knows about, which one(s) the BASS is connected to, and whether the BASS wants a Broadcast Assistant to help the BASS manage that information and help the BASS to make connections. Moreover, the BASS works with the broadcast assistants to manage broadcast connections that the users select and manage. The BASS is a key part of expanding the broadcast ecosystem, using BLE connections to assist in the distribution and control of broadcast information. Table 1 below illustrates the characteristics of the BASS:

TABLE 1

| Characteristic | Properties | Quantity |
|---|---|---|
| Broadcast Audio Scan | Write, write without | Only one |
| Control Point | a response | |
| Broadcast Receive State | Read, Notify | One or more |

Devices that host the BASS and manage its characteristics are referred to as BASS servers, which can include devices like earbuds, headsets, and hearing aids. On the other hand, devices that interact with the BASS characteristics are called BASS clients, which may include phones, tablets, TVs, and watches. Furthermore, a source operation involves a procedure where the BASS client shares broadcast source information with the BASS server and requests the BASS server to synchronize with the PA transmitted by the broadcast source and subsequently synchronize with the BIS from the broadcast source.

FIG. 6 illustrates a diagram depicting Periodic Advertising Synchronization Transfer (PAST) 600, according to the related art. In this process, a broadcast assistant 603 scans for advertisements that indicate the presence of extended advertisements, functioning like any other scanning device. The advertisements may be broadcast by an audio source 601. Once the broadcast assistant 603 discovers these advertisements, it may synchronize with the associated periodic advertising train, which includes a broadcast audio announcement service UUID. The broadcast assistant then identifies the accompanying BIGInfo and BASE structure. Before reading and parsing the BASE metadata, the broadcast assistant 603 may apply filters to the scan results. Afterward, it provides the user with a list of available broadcast streams, typically showing human-readable ProgramInfo. Once the user makes a selection, the broadcast assistant 603 employs the PAST procedure to transfer the relevant information to the broadcast receiver (also called the broadcast sink) 605. This allows the broadcast receiver 605 to directly access the appropriate advertising packets, retrieve the BIGInfo and BASE, and synchronize with the Broadcast Isochronous Streams (BISes) without needing to perform additional scanning. This efficient process is referred to as PAST.

FIG. 7 illustrates a sequence flow diagram 700 for Broadcast Stream Rendering (BSR), according to the related art. As shown in FIG. 7, at steps 701a and 701b, the LE connection is established between an audio source 702 (such as a mobile) and the left bud 704 and the right bud 706. At step 703, the user clicks on the find broadcast button to find nearby broadcast sources. At step 705, the mobile finds the broadcast source and the user clicks on the listed broadcast source in the UI. At step 707, the audio source 702 sends Add Source Command to the left bud 704. At step 709, the audio source 702 sends an add source command to the right bud 706. At step 711, the left bud 704 and the right bud 706 request the PAST information from the audio source 702. At step 713, the audio source 702 sends the PAST information to both the buds 704, and 706. At steps 715a, and 715b, the buds 704, and 706 are now synced with the PA and simultaneously with the BIS. At steps 717a, and 717b, both the buds 704, and 706 start rendering the BIS packets.

Further, a broadcast_code is used to decrypt an encrypted BIS. The “Set Broadcast_Code” operation is used by the user to provide a Broadcast_Code to the server to enable the server to decrypt the encrypted BIS. The broadcast assistant may obtain the broadcast code by using an out-of-band method such as over a Bluetooth link, via the NFC, via the QR code, and many more, as shown in below Table 2:

TABLE 2

| | Size (Octets) | Description |
|---|---|---|
| Opcode | | |
| 0x04 | 1 | 0x04 = Set Broadcast_Code Operation |
| Parameter | | |
| Source_ID | 1 | Source_ID assigned by the server to a |
| | | Broadcast receive state characteristic |
| Broadcast Code | 16 | Broadcast_Code for the Source_ID |
| | | assigned to a Broadcast receive state |
| | | characteristic |

In an existing method of joining LE audio broadcast through scan and select source, each user must navigate to a connection page for multiple user actions. The user clicks on a “find broadcast” button. The user then scans for the broadcaster and selects the broadcaster. Then, the user sends synchronization information to the broadcast receiver to join the broadcast. When a group of users has to perform these steps individually, it results in unnecessary power consumption and delays before everyone is connected. For example, a group of four users visits a place with a broadcast source 1 having a silent TV broadcasting. The first user decides to listen to music playing on a silent TV in the place and connects their buds to the phone. The user navigates to the buds connection page, clicks on “find broadcast,” and waits for the available broadcasts to be listed. After selecting the broadcast of silent TV, the user enters a password, synchronizes to the broadcast, and begins listening. However, when the second, third, and fourth users attempt to synchronize to the same broadcast, the users must repeat the entire process individually, as there is no way to share the broadcast. This results in each user consuming approximately 4 to 5 mAh of power, with the entire synchronization process taking around 8-10 seconds per user.

In another example scenario, a group of four users are present in a shopping mall. Every shop in the mall may have broadcast sources advertising products/discounts/entertainment. If any area has multiple broadcast sources with duplicate names, then the user has a high probability of not finding the broadcast source of his interest in, joining a broadcast with a duplicate name, or even worse joining a broadcast source that mimics another source with a malicious intent. For example, a first user (user 1) wants to connect with a Burger shop broadcast source name broadcast source 2. But there are multiple broadcasters with the same name. Similarly, a second user (user 2) is trying to search broadcast source namely Fashion. But his screen is filled with multiple other broadcast sources. Further, a third user (user 3) is connected to the broadcast source 2. However, he found out that it is a different broadcaster with the same name, and the intended source is not even listed in a user interface (UI). This could be a malicious broadcast source too. Similarly, a fourth user (user 4) wanted to connect to the broadcast source 2 broadcast source through a Tap/QR code because of multiple broadcasters with the same name but he is very far away from the source.

In another example of broadcasting code and password sharing, a group of four users is watching a football match, and the first user enables a private broadcast on the TV to minimize disturbance to the neighbors. The first user (user 1) connects to the private broadcast using their buds by scanning and syncing through their phone. To do so, the first user (user 1) navigates to the buds connection page, clicks on the “find broadcast” button, waits for the broadcast to appear, and then enters a password to synchronize and listen to the broadcast. However, the second, third, and fourth users (user 2, user 3, user 4) must repeat this entire process to access the same football match broadcast, as there is no way to share the stream directly. As a result, each user must manually go to the TV settings to display the QR code for the broadcast code or rely on the first user to verbally share the password with them. This limitation in related art broadcasting not only creates unnecessary steps but also results in wasted time and effort, complicating the experience for all users involved.

FIG. 8 illustrates an example 800 depicting a scenario of a malicious broadcast, according to the related art. In this scenario, a user is in a public space with friends, surrounded by multiple LE audio broadcast sources from various places like convenience stores, public transport systems, restaurants, and gas stations. While most of these sources are genuine, some may be malicious imposters designed to imitate authentic LE audio broadcast sources by using identical names and metadata. These fake broadcast sources can mislead LE audio broadcast consumers, tricking them into connecting to a malicious source that can transmit harmful data via broadcast isochronous streams. The user's friend, the second user, informs the first user to connect to the LE audio broadcast source from the bus stop to get real-time bus updates. However, due to the lack of clear methods to distinguish authentic broadcast sources from fake ones, the first user is at high risk of inadvertently joining a malicious broadcast from a fake bus stop. This could result in harmful consequences, as the user may unknowingly receive and interact with malicious data. The scenario highlights the importance of mechanisms to verify and authenticate LE audio broadcast sources to protect users from such threats.

The currently available methods of sharing the audio data do not support resharing of the broadcast source. Further, the currently available methods require a significant number of steps to be performed to join the broadcast which result in high power consumption and high latency in joining the broadcast.

In current methods of joining an LE audio broadcast, several significant drawbacks arise, particularly when a group of users is trying to connect to the same broadcast. These issues can greatly diminish user experience and present challenges that need to be addressed as the audio broadcast adoption increases. Some of the drawbacks are as follows:

Duplicate Broadcast Names: When users attempt to join a broadcast, each user must navigate to the buds connection page, click on “find broadcast,” and scan for the available broadcasters. If multiple broadcast sources use the same name, such as “broadcast source-1” or “broadcast source-2,” this can create confusion for users, as the LE audio specification does not mandate unique names for broadcasters. This lack of distinct identification makes it difficult for users to know which broadcaster to choose, leading to a frustrating user experience, especially in environments with many similar broadcast sources.

Bad User Experience (Multiple User Actions): The process of connecting to a broadcast involves several repetitive steps: navigating to the buds connection page, finding the broadcast, selecting the broadcaster, and syncing with the buds. If a group of users is trying to connect to the same broadcast, each user must independently go through this process, resulting in unnecessary time delays and power consumption. It is estimated that this process can take around 8-10 seconds and consume approximately 4-5 mAh of battery per user. This lengthy and energy-draining process is inconvenient and inefficient, particularly for group scenarios.

Password Sharing: In cases where the broadcast is secured, users must manually enter a password to join. Each user must locate the password and input it correctly, which adds further friction to the process. This step is cumbersome, especially in group settings where the password needs to be shared multiple times.

Risk of Joining Malicious Broadcast Sources: Malicious actors may create fake broadcast sources that imitate the names of genuine broadcasters (e.g., using the same Audio broadcast source name). This poses a security risk, as users may inadvertently connect to a harmful broadcast source, which could deliver malicious data to their devices. The lack of a robust mechanism to verify and differentiate between legitimate and fake sources adds to the vulnerability of the users.

Fixed Nature of QR Codes and NFC Tap Pods: QR codes and NFC tap pods provide alternative ways to join a broadcast, but the users must be physically displayed and remain in fixed locations. This requires each user to walk up to the QR code or NFC pod to scan or tap and join the broadcast. This method is inconvenient, especially in crowded spaces, and limits the flexibility of joining a broadcast remotely or seamlessly.

However, there is currently no established technique in the audio broadcast that allows one user who has already connected to a broadcast to share that connection information with another user. As a result, each user must go through the entire process independently, creating inefficiency and a poor user experience. Additionally, the process consumes unnecessary battery power (4-5 mAh) and takes 8-10 seconds, further diminishing user satisfaction.

Given the increasing use of the audio broadcasts, these issues are becoming more prominent and need to be addressed to improve the overall user experience, streamline connection processes, and mitigate security risks.

Therefore, in view of the above-mentioned problems, it is advantageous to provide an improved system and method that can overcome the above-mentioned problems and limitations associated with audio broadcasting.

### SUMMARY

This summary is provided to introduce a selection of concepts, in a simplified format, that are further described in the detailed description of the disclosure. This summary is neither intended to identify key or essential concepts of the disclosure nor is it intended for determining the scope of the disclosure.

According to an aspect of the disclosure, a method for sharing broadcast source information, includes: determining, by a sender device, whether broadcast source information associated with an audio broadcast session is to be shared with at least one receiver device based on a user input from a user of the sender device and a request from the at least one receiver device; based on determining that the broadcast source information is to be shared with the at least one receiver device, selecting, by the sender device, a transmission medium from among a plurality of transmission mediums for sharing the broadcast source information; and transmitting, by the sender device, at least one data packet over the transmission medium, the at least one data packet including the broadcast source information.

According to an aspect of the disclosure, a device includes: memory storing instructions; and at least one processor, wherein the instructions, when executed by the at least one processor individually or collectively, cause the device to: determine whether broadcast source information associated with an audio broadcast session is to be shared with at least one receiver device based on a user input from a user of a sender device and a request from the at least one receiver device; based on determining that the broadcast source information is to be shared with the at least one receiver device, select a transmission medium from among a plurality of transmission mediums for sharing the broadcast source information; and transmit at least one data packet over the transmission medium, the at least one data packet including the broadcast source information.

According to an aspect of the disclosure, a non-transitory computer-readable recording medium stores instructions that are executed by at least one processor to perform a method for sharing broadcast source information, the method including: determining, by a sender device, whether broadcast source information associated with an audio broadcast session is to be shared with at least one receiver device based on a user input from a user of the sender device and a request from the at least one receiver device; based on determining that the broadcast source information is to be shared with the at least one receiver device, selecting, by the sender device, a transmission medium from among a plurality of transmission mediums for sharing the broadcast source information; and transmitting, by the sender device, at least one data packet over the transmission medium, the at least one data packet including the broadcast source information.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an example scenario depicting Low Energy (LE) audio broadcast Bluetooth technology for broadcasting audio, according to the related art;

FIG. 2 illustrates a timing diagram depicting the broadcasting of the audio using Broadcast Isochronous stream (BIS), according to the related art;

FIG. 3 illustrates an example 400 depicting periodic advertising (PA) events from the same advertising set, according to the related art;

FIG. 4 illustrates an example of a Broadcast Isochronous Group (BIG) for broadcasting audio, according to the related art;

FIG. 5 illustrates an example depicting extended advertising (EA) for the BIG, according to the related art;

FIG. 6 illustrates a diagram depicting Periodic Advertising Synchronization Transfer (PAST), according to the related art;

FIG. 7 illustrates a sequence flow diagram for Broadcast Stream Rendering (BSR), according to the related art;

FIG. 8 illustrates an example depicting a scenario of a malicious broadcast, according to the related art;

FIG. 9 illustrates a scenario of sharing broadcast source information between broadcast assistant devices, according to one or more embodiments of the present disclosure;

FIG. 10 illustrates a flow diagram of a method of sharing broadcast source information during an audio broadcast session, according to one or more embodiments of the present disclosure;

FIG. 11A and FIG. 11B illustrate sequence flow diagrams of an example method for sharing broadcast source information between the broadcast assistant devices, according to one or more embodiments of the present disclosure;

FIG. 12 illustrates a line diagram depicting a method for sharing the broadcast source information between the broadcast assistant devices using near field communication (NFC), according to one or more embodiments of the present disclosure;

FIG. 13 illustrates a line diagram depicting a method for sharing the broadcast source information between the broadcast assistant devices using a QR code, according to one or more embodiments of the present disclosure;

FIG. 14 illustrates a line diagram depicting a method for sharing the broadcast source information between the broadcast assistant devices using near share, according to one or more embodiments of the present disclosure;

FIG. 15 illustrates a line diagram depicting a method for sharing the broadcast source information between the broadcast assistant devices using web service, according to one or more embodiments of the present disclosure;

FIG. 16 illustrates a scenario of sharing broadcast source information between broadcast assistant devices using a server, according to one or more embodiments of the present disclosure;

FIG. 17 illustrates a scenario of sharing broadcast source information between broadcast assistant devices using a targeted announcement, according to one or more embodiments of the present disclosure;

FIG. 18 illustrates an example depicting a reduction in the risk of joining malicious broadcasts, according to one or more embodiments of the present disclosure;

FIG. 19 illustrates a use case scenario for sharing the broadcast source information between the broadcast assistant devices, according to one or more embodiments of the present disclosure;

FIG. 20 illustrates a line diagram depicting steps for a method of sharing the broadcast source information between the broadcast assistant devices for the example case scenario of FIG. 23, according to one or more embodiments of the present disclosure;

FIG. 21 illustrates an architecture of a system for sharing the broadcast source information between the broadcast assistant devices, according to one or more embodiments of the present disclosure;

FIG. 22 illustrates an environment for sharing broadcast source information via a button in a broadcast assistant User Interface (UI), according to one or more embodiments of the present disclosure; and

FIG. 23 illustrates a block diagram of a system of sharing broadcast source information during an audio broadcast session, according to one or more embodiments of the present disclosure.

### DETAILED DESCRIPTION

For the purpose of promoting an understanding of the principles of the present disclosure, reference will now be made to the various embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Further, it will appreciated that elements in the drawings are illustrated for simplicity and may not have necessarily been drawn to scale. For example, the flow charts illustrate the method in terms of the most prominent steps involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

Whether or not a certain feature or element was limited to being used only once, it may still be referred to as “one or more features” or “one or more elements” or “at least one feature” or “at least one element.” Furthermore, the use of the terms “one or more” or “at least one” feature or element does not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfill the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, “includes”, “including”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises/includes . . . a” does not, without more constraints, preclude the existence of other devices or other sub-systems or other elements or other structures or other components or additional devices or additional sub-systems or additional elements or additional structures or additional components.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

Moreover, multiple functions described below may be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data may be permanently stored and media where data may be stored and later overwritten, such as a rewritable optical disc or an erasable memory device.

The present disclosure provides techniques for enabling re-sharing of broadcast source information in LE audio broadcast systems. The disclosed techniques address a critical gap in the current framework, where the users cannot share the broadcast information between their devices. The disclosed techniques greatly enhance the efficiency and user experience, especially in group settings where multiple users are interested in the same broadcast.

Embodiments of the present disclosure will be described below in detail with reference to the accompanying drawings.

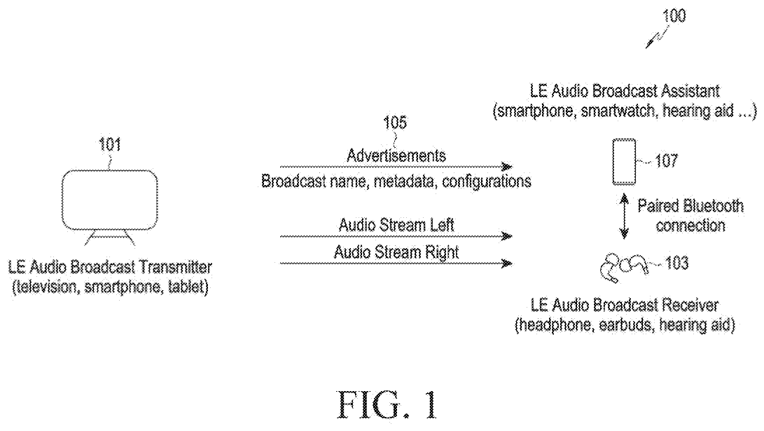

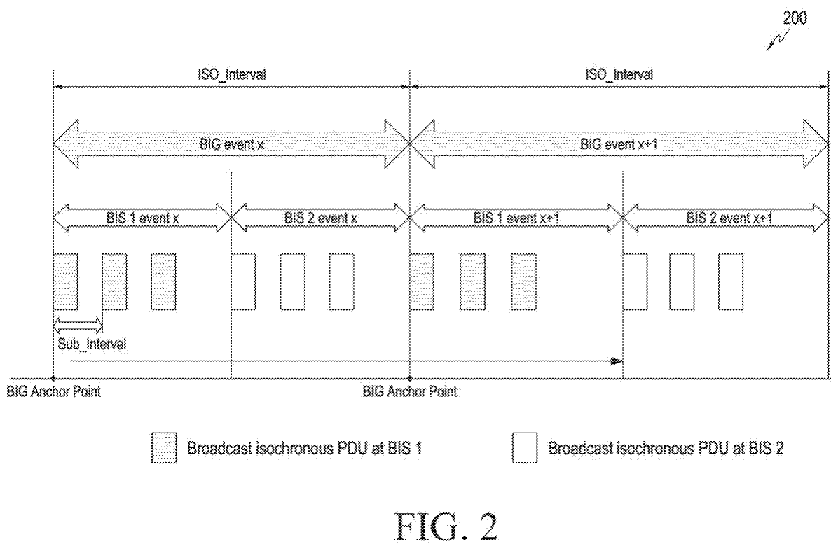

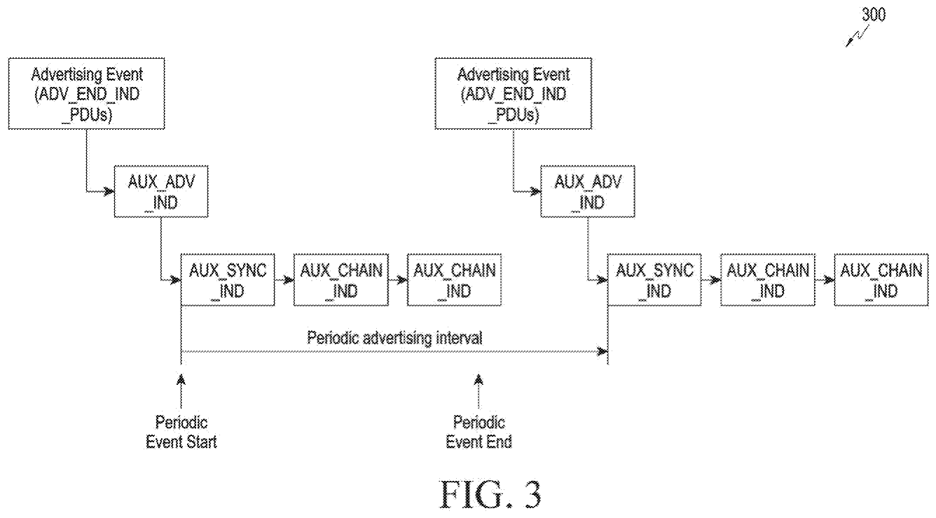

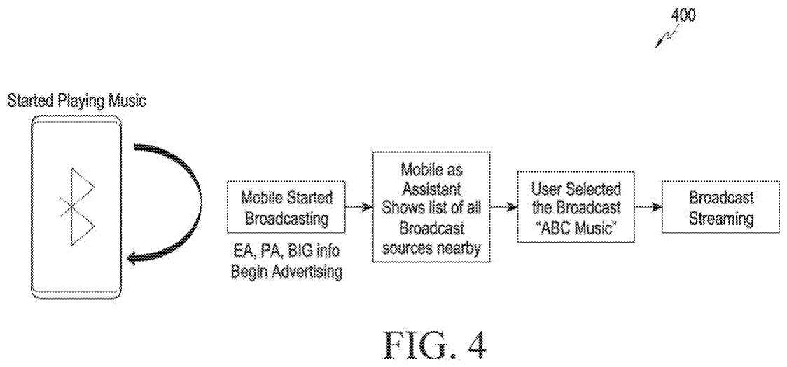

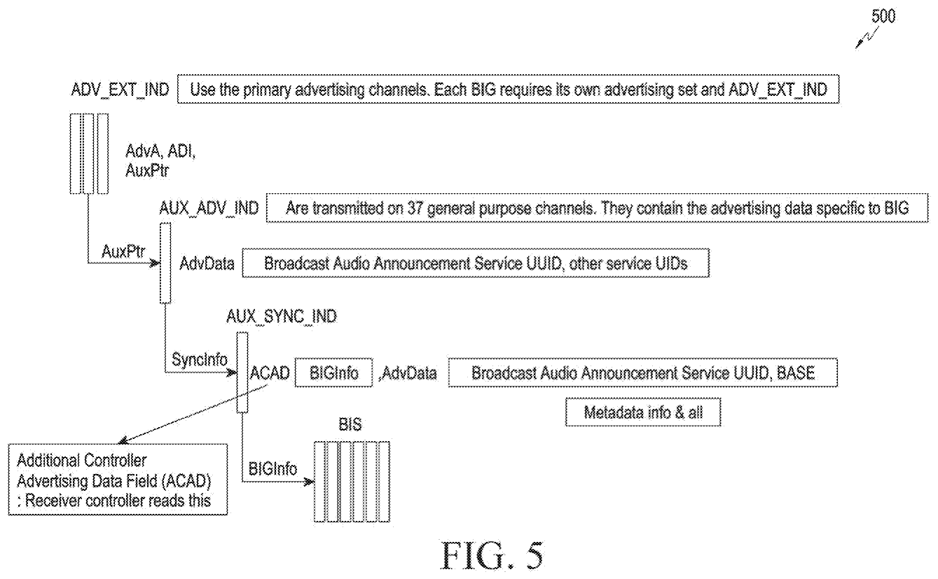

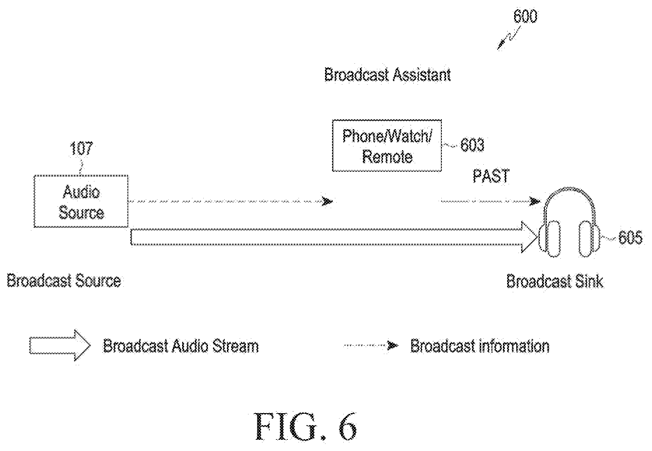

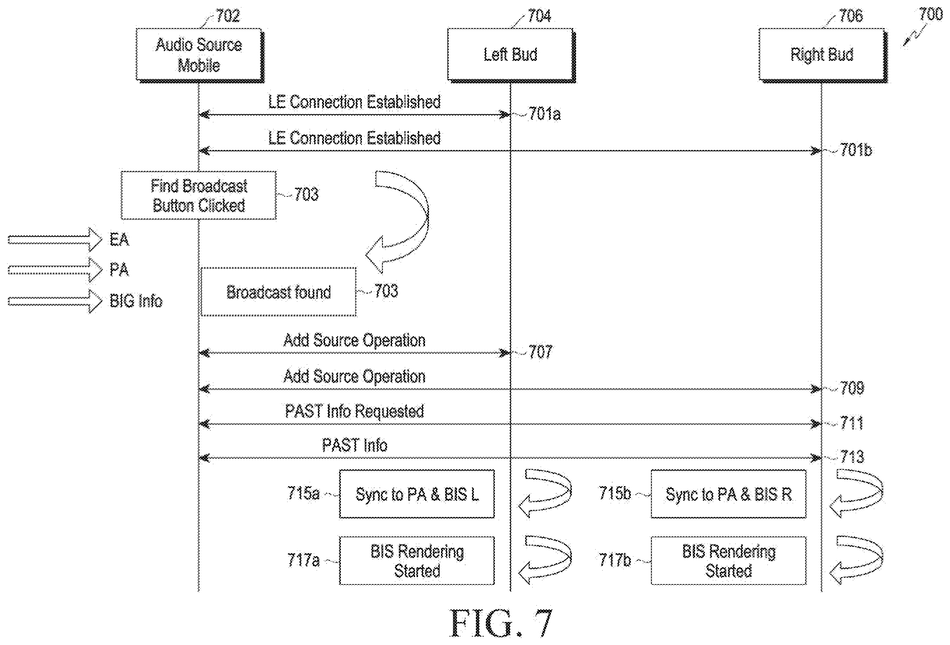

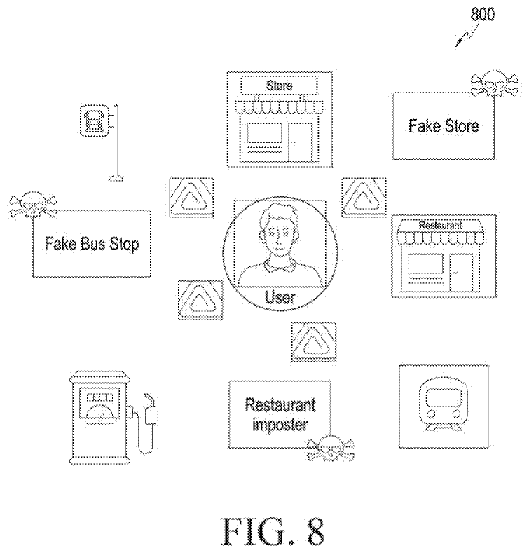

For the sake of clarity, the first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2.

It should be noted that the terms “broadcast session” and “audio broadcast session” have been interchangeably used throughout the description. Further, the terms “broadcast assistant devices” have been interchangeably used with “users” throughout the description.

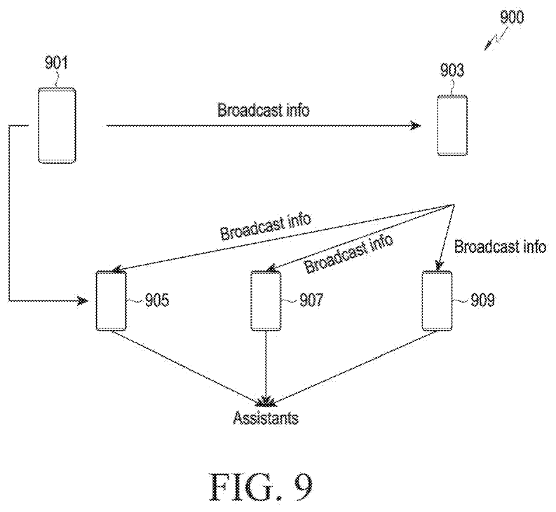

FIG. 9 illustrates a scenario 900 of sharing broadcast source information between broadcast assistant devices, according to one or more embodiments of the present disclosure. The present disclosure offers a solution where user A, after successfully syncing to an LE audio broadcast, can share the broadcast source information with other users (e.g., user B, user C, and user D) through their assistant devices. This removes the need for each user to repeat the entire process of scanning and syncing individually. For example, as shown in FIG. 9, a group of four users, also referred to as broadcast assistant devices 903, 905, 907, and 909 visits a place named XYZ, which is transmitting multiple LE audio broadcasts, all with the same or similar names (e.g., XYZ-1, XYZ-2). This creates confusion for the users as the users struggle to identify the correct broadcast to sync to. User A 903 goes to the place counter and syncs to the actual broadcast stream of the broadcast source 901. After syncing, user A 903 can share the broadcast information (info) with the remaining users in the group (user B 905, user C 907, and user D 909) using one of the following methods:

QR Code Sharing: User A 903 generates a QR code containing the broadcast information, and the others simply scan it to connect.

NFC Tap Sharing: User A 903 shares the broadcast details by allowing the other users to tap their devices on User A's device using NFC.

Bluetooth Sharing: User A 903 shares the broadcast details via Bluetooth to nearby devices.

Family Account Sharing: If all the users (903, 905, 907, 909) are part of a shared family or group account, the broadcast details are automatically shared, allowing them to sync without further action.

Accordingly, users B, C, and D sync to the broadcast without needing directly to sync with the broadcast source 901, or manually search for the broadcast.

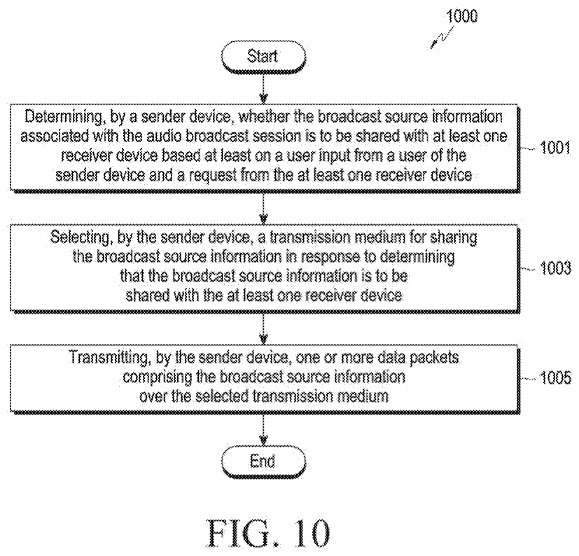

The techniques as discussed in reference to FIG. 9 are further explained in reference to FIG. 10. Accordingly, FIG. 10 has been explained in conjunction with FIG. 9.

FIG. 10 illustrates a flow diagram of a method 1000 of sharing broadcast source information during an audio broadcast session, according to one or more embodiments of the present disclosure. It should be noted that the method 1000 may be performed between a sender device and at least one receiver device, wherein the sender and the at least one receiver device correspond to broadcast assistant devices in an audio broadcast environment. For example, the sender device may correspond to device 903 and the at least one receiver device may correspond to devices (905, 907, and 909) of FIG. 9. Further, the sender device 903 and the at least one receiver device (905, 907, and 909) are part of a connected network, such as a cloud network, a family group connected over a same network (e.g., home Wi-Fi network), a friend group connected over a same network (e.g., office Wi-Fi network) and similar connected networks. Further, the method 1000 may be performed at the sender device 903.

Referring to FIG. 10, at step 1001, the method 1000 may include determining whether the broadcast source information associated with the audio broadcast session is to be shared with at least one receiver device. In an embodiment, the sender device 903 may determine whether the broadcast source information is to be shared with at least one receiver device (905, 907, 909) based on a user input from a user of the sender device 903. In another embodiment, the sender device 903 may determine whether the broadcast source information is to be shared with at least one receiver device (905, 907, 909) based on a request from the at least one receiver device (905, 907, 909). In an embodiment, the sender device 903, also referred to as a broadcast assistant 1 (BA1) may be connected to the broadcast source before determining whether the broadcast source information is to be shared with at least one receiver device (905, 907, 909), also referred to as a broadcast assistant 2 (BA2). The BA1 may be connected to an audio headset broadcast sink1 (BS1). The BA1 may assist the BS1 to sync to the broadcast source selected by the user of the BAL and the BS1. In an embodiment, the user of the BA1 may provide a user input to share the broadcast information with the BA2. For example, the user of the BA2 may click on share via a button in the BA1. In another embodiment, the BA2 may inform the BA1 that the broadcast source information is to be shared, such as via a message.

Thereafter, at step 1003, the method 1000 may include selecting a transmission medium among a plurality of transmission mediums for sharing the broadcast source information. Step 1003 may be performed in response to determining that the broadcast source information is to be shared with the at least one receiver device (905, 907, 909). In an embodiment, the plurality of transmission mediums may include but not limited to a Bluetooth (BT), a Bluetooth Low Energy (BLE), a Wi-Fi, a Near Field Communication (NFC), a nearby share, web based sharing, a Quick Response (QR) code, or an out of band (OOB) communication. Further, the sender device 903, i.e., the BA1 may receive a user-selection input from the user of the sender device 903 to select the transmission medium. For example, the BA1 may display various transmission mediums for sharing the broadcast information and the user may select the transmission medium among the various transmission mediums. In another embodiment, the sender device 903 may receive a request message, from the at least one receiver device (905, 907, 909). The request may include the transmission medium to use for sharing the broadcast information and the user may select the transmission medium among the various transmission mediums.

Accordingly, at step 1005, the method 1000 may include transmitting one or more data packets comprising the broadcast source information over the selected transmission medium. The one or more data packets may include but are not limited to a broadcast source identification (ID), a name of the broadcast source, a broadcast code, metadata related to broadcast content, an address of the broadcast source, and an address type of the address of the broadcast source.

In an example embodiment, if the transmission medium is a QR code, the QR code is generated using the broadcast source information object and displayed on the UI of the BA1. However, if the NFC is chosen, the BA1 begins to act as an NFC Tap point. However, if the transmission medium is BT or the near Share, the BA1 may act as a data sender device. Further, if the transmission medium is, then the broadcast source information may be shared in the cloud.

Accordingly, the BA2 may use the broadcast source information to connect with the broadcast source 901. For example, if the broadcast source information is shared via the NFC tap point, the BA2 may tap on the BA1 to receive the broadcast source information. If the BA1 generates the QR code, the BA2 may scan the QR code to get the broadcast source information. If the BA1 is shared via the BT or the near share, the broadcast source information may be received by the BT or the near share application. If the broadcast source information is shared using the web, the BA2 may download the broadcast source information from the cloud.

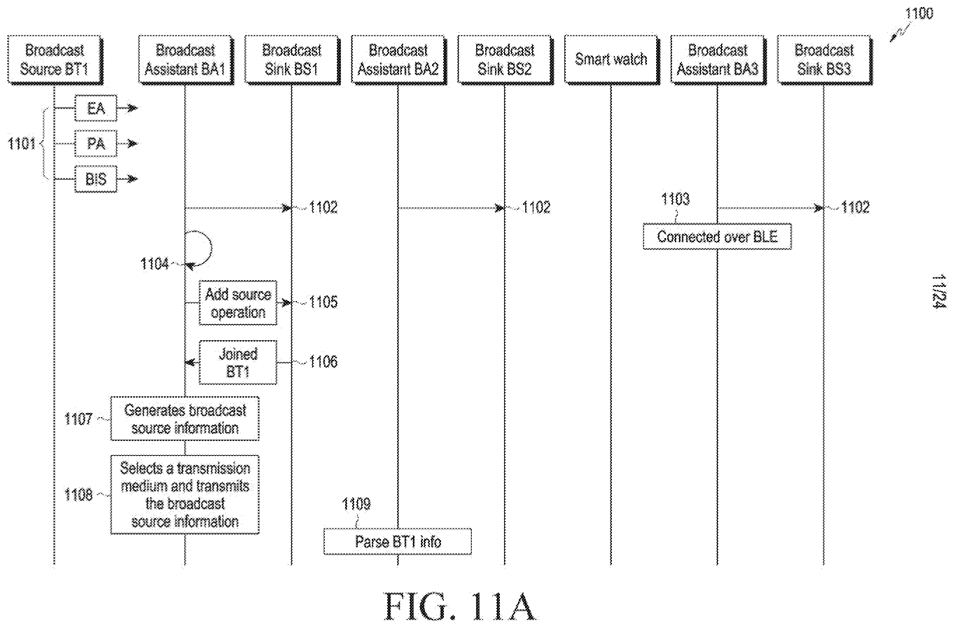

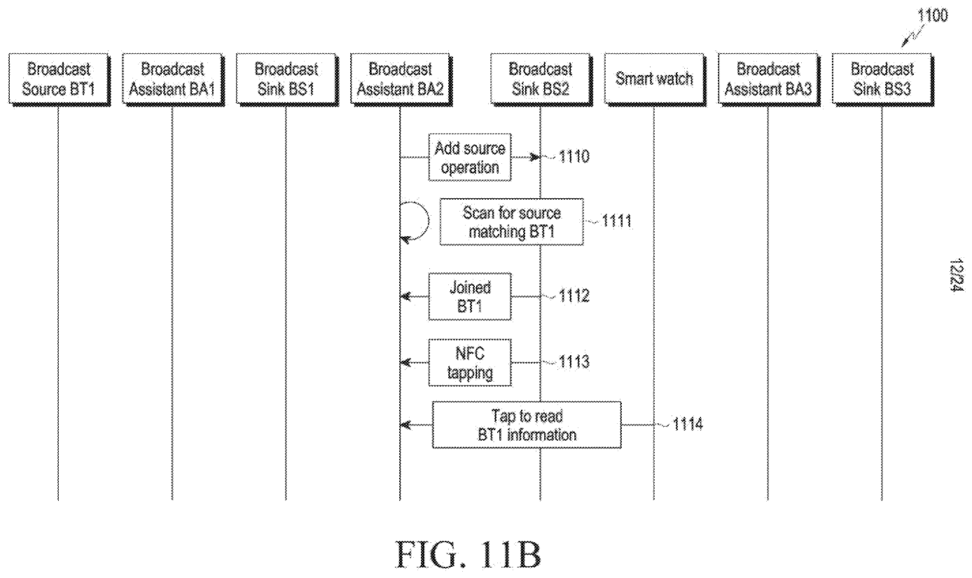

The BA2 may parse the broadcast source information to get details about the broadcast source 901. Accordingly, the BA2 can help a broadcast sink 2 (BS2) associated with the BA2, to join the broadcast session on the broadcast source information provided by the BA1, using one of the following methods:
A. If the broadcast source information received is sufficient to join the broadcast session, that is, if the BA2 has received the periodic advertisement (PA) sync information, then the BA2 may perform an add source operation to assist the BS2 in joining the broadcast session.
B. If the information received is not sufficient to join the broadcast, that is if the BA2 has not received the PA sync information from the BA1, then the BA2 may automatically perform a scan to find the broadcast source 901 that matches the broadcast source information. Once found, the BA2 may perform an add source operation. The method 1000 has been further described in detail in reference to FIGS. 11A to 22.

FIGS. 11A and 11B illustrate-sequence flow diagrams of an example method 1100 for sharing broadcast source information between the broadcast assistant devices, according to one or more embodiments of the present disclosure. At step 1101, the broadcast source (BT1) starts the broadcast session and sends out the EA, the PA, and the BIS. At step 1102, devices BA1-BS1, BA2-BS2, and BA3-BS3 establish connections over BLE. At step 1103, a non-LE audio-supported device such as a smart watch is connected to the BA3 over a BT/BLE link. At step 1104, the user of the BA1 initiates a scan for nearby broadcast sources and lists all the available broadcast sources. The user selects BT1 from the list of all the available broadcast sources. At step 1105, the BA1 performs an add source operation with the BS1, allowing BS1 to join the BT1 broadcast session. At step 1106, the BS1 successfully joins the BT1 and informs the BA1. At step 1107, the BA1 enables the “share via” feature and generates the broadcast source information associated with the broadcast source BT1, also referred to as BT1 information. At step 1108, the user selects a transmission medium (e.g., QR code, NFC Tap, Quick Share, Bluetooth, or Family account) to share BT1 information with BA2. At step 1109, the BA2 parses the BT1 information, retrieving details such as the broadcast ID, name, code, address, etc. At step 1110, if the BT1 information is sufficient, the BA2 performs the add source operation with the BS2, syncing BS2 with BT1. At step 1111, if the BT1 information is insufficient, the BA2 scans for nearby broadcasts matching the BT1 details. Upon finding a match, the BA2 stops scanning and completes the add source operation to help the BS2 sync with the BT1. At step 1112, the BS2 informs the BA2 upon successfully joining the BT1. Further, the BA2 enables sharing via its UI, generating an informational object similar to the BA1. At step 1113, the non-LE audio device with NFC can tap the BA2 and receive the BT1 information. At step 1114, the non-LE audio device shares the received BT1 information with the BA3 over Bluetooth/BLE. Steps 1108-1114 are repeated for other devices like BS3. If any BS loses synchronization with the BT1, it informs its corresponding BA, which disables the “share via” button in the UI, indicating a loss of sync. Accordingly, the disclosed method outlines an efficient way to share the broadcast source information between multiple devices, enabling smooth synchronization across different users and improving the overall user experience in broadcast scenarios.

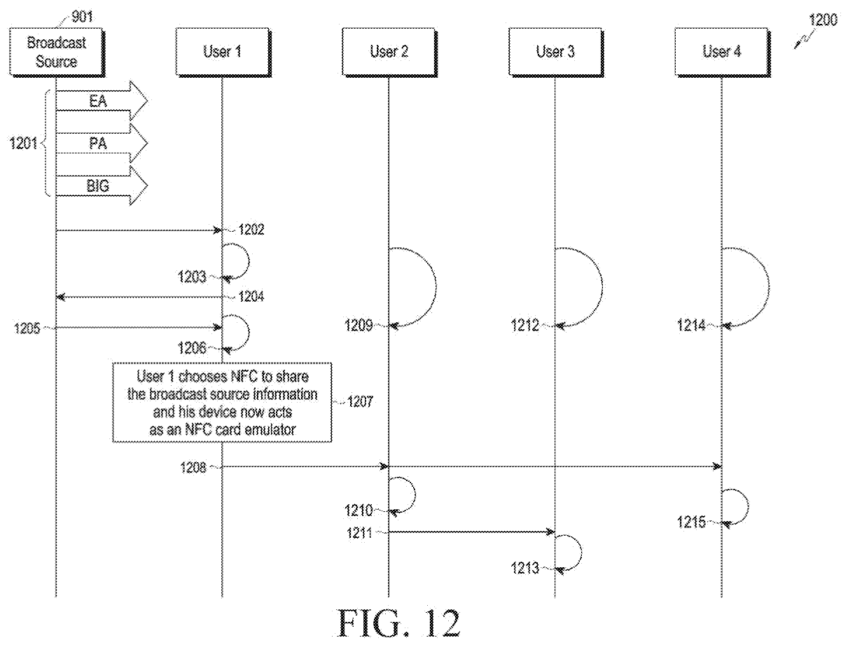

FIG. 12 illustrates a line diagram depicting a method 1200 for sharing the broadcast source information between the broadcast assistant devices using NFC, according to one or more embodiments of the present disclosure. In an example embodiment, four users. i.e., user 1, user 2, user 3, and user 4 visited a place called XYZ. While there, the users wanted to listen to the cafe's ongoing broadcast. However, when the users searched for available broadcasts, the users found four different options all named “XYZ,” which left the users confused about which one to connect to. To resolve the issue, the user 1 went to the counter and scanned for the correct broadcast. Now, for the other users to listen as well, the other users each need to either go to the counter and scan the QR code or tap the designated NFC point to receive the broadcast information. Accordingly, the present disclosure provides a solution to the above problem as shown in FIG. 12. In an embodiment, the broadcast source 901 may broadcast songs during the audio broadcast session. At step 1201, the broadcast source 901 broadcasts EA, PA, and BIG. At step 1202, the user 1 joins the broadcast session using the related art method as discussed above. At step 1203, the user 1 performs the add source operation. At step 1204, the user 1 transmits a sync info request to the broadcast source 901. At step 1205, the user 1 receives PAST information from the broadcast source 901 in response to the sync info request. At step 1206, the user 1 syncs to PA. At step 1207, a share via option in enabled in the UI of the device of the user 1. Accordingly, the user 1 selects NFC as a transmission medium to share the broadcast source information and his device now acts as an NFC card emulator. At step 1208, the user 1 shares the broadcast source information with the user 2 via NFC. At step 1209, the user 2 joins the broadcast session by simply tapping his device with the device of the user 1, bypassing the related art steps. At step 1210, the user 2 performs the add source operation and syncs to the PA. At step 1211, the user 2 shares the broadcast source information with the user 3. At steps 1212 and 129, the user 3 syncs to the PA similar to steps 1209-1210. Further, at steps 1214 and 1215, the user 4 syncs to the PA similar to steps 1209-1210 after receiving the broadcast source information from the user 3.

In another embodiment, the broadcast source information can be shared using Bluetooth instead of NFC, as described with reference to FIG. 12. In this case, users 903, 905, 907, and 909 may connect to the broadcast source 901 by making their devices discoverable via Bluetooth. The process is similar to the one described in FIG. 12, with the only difference being the use of Bluetooth as the transmission medium for sharing the broadcast source information.

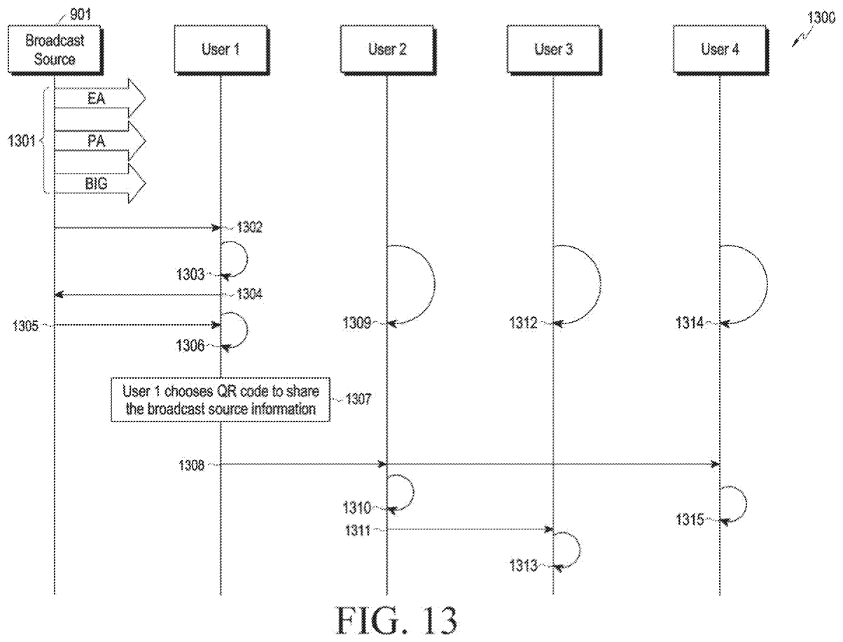

FIG. 13 illustrates a line diagram depicting a method for sharing the broadcast source information between the broadcast assistant devices using a QR code, according to one or more embodiments of the present disclosure. It should be noted that steps 901-1306, 1310-1311, 1313, and 1315 are the same as steps 1201-1206, 1210-1211, 1213, and 1215. Hence, the description of the same is not reproduced for the sake of brevity of the description. The process is similar to the one described in FIG. 12, with the only difference being the use of the QR code as the transmission medium for sharing the broadcast source information. Accordingly, at step 1307, a share via option in enabled in the UI of the user 1 903 device. Accordingly, the user 1 selects the QR code as a transmission medium to share the broadcast source information, and the QR code is displayed on the device of the user 1. At step 1308, the user 1 shares the broadcast source information with the user 2 via QR code. At step 1309, the user 2 opens the QR code scanner app on his device to get the broadcast source information. The user 2 scans the QR code shared by the user 1 and joins the broadcast session, bypassing the related art steps. Further, at steps 1311-1312, the user 3 syncs to the PA similar to steps 1308-1310 after receiving the broadcast source information from the user 2. Similarly, at step 1314, the user 4 syncs to the PA similar to steps 1309-1310 after receiving the broadcast source information from the user 3.

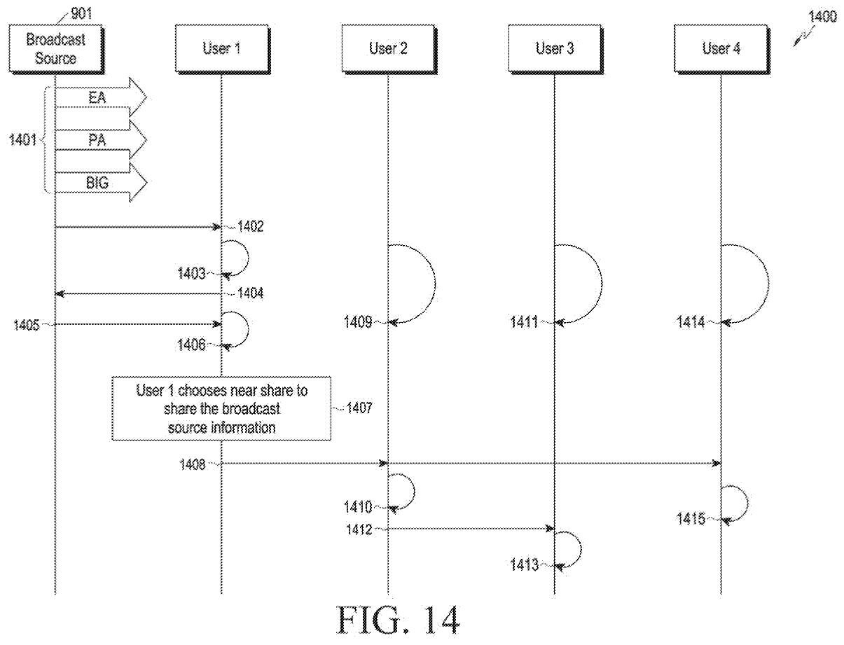

FIG. 14 illustrates a line diagram depicting a method for sharing the broadcast source information between the broadcast assistant devices using near share, according to one or more embodiments of the present disclosure. It should be noted that steps 1401-1406, 1410-1411, 1413, and 1415 are the same as steps 1401-1406, 1410-1411, 1413, and 1415. Hence, the description of the same is not reproduced for the sake of brevity of the description. The process is similar to the one described in FIG. 12, with the only difference being the use of near share as the transmission medium for sharing the broadcast source information. Accordingly, at step 1407, a share via option in enabled in the UI of the user 1 903 device. Accordingly, the user 1 selects near share as a transmission medium to share the broadcast source information. At step 1408, the user 1 shares the broadcast source information with the user 2 via the near share. At step 1309, the user 2 accepts the request shared by the user 1 via the near share to get the broadcast source information. Further, at steps 1411-1412, the user 3 syncs to the PA similar to steps 1408-1410 after receiving the broadcast source information from the user 2. Similarly, at step 1414, the user 4 syncs to the PA similar to steps 1409-1410 after receiving the broadcast source information from the user 3.

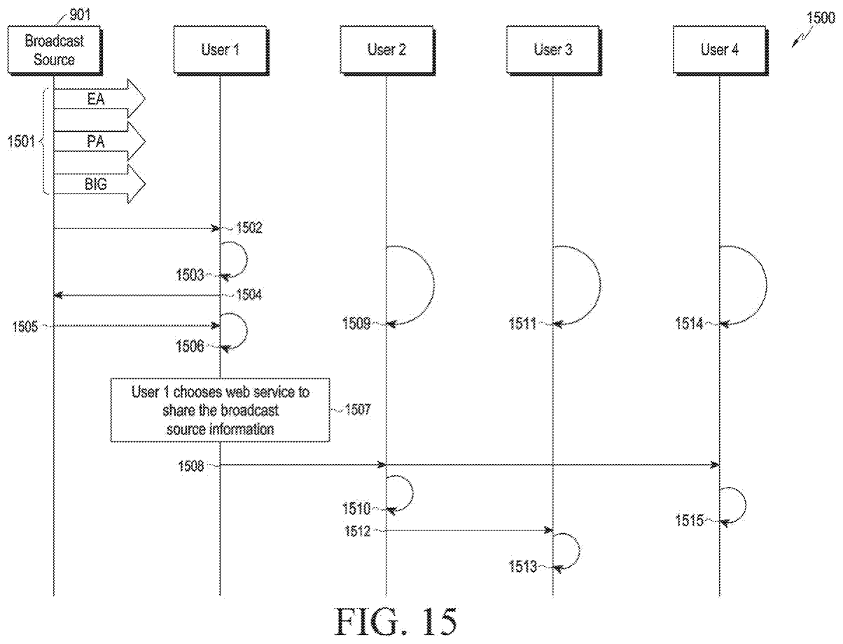

FIG. 15 illustrates a line diagram depicting a method for sharing the broadcast source information between the broadcast assistant devices using web service, according to one or more embodiments of the present disclosure. In an example embodiment, a group of four users is watching a football game together. The first user connects to the TV's broadcast service using family sharing and suggests the broadcast to the others in the group. The other users agree and connect to the TV's broadcast via family sharing by making their devices discoverable through their device UI. The users can click on the broadcast and join directly without needing a password. The first user opens the Family Sharing UI on their device, enters the second user's contact number, and adds them to the family group. Afterward, the first user edits the group members to include the third and fourth users. By clicking “Invite,” the first user sends an invitation to the others. Meanwhile, the second user opens the assistant UI on their device and connects to the first user's TV directly without having to enter the broadcast code. Accordingly, the broadcast source information may be shared using family sharing, referred to as web service, as discussed in reference to FIG. 15. It should be noted that steps 1501-1506, 1510-1511, 1513, and 1515 are the same as steps 1501-1506, 1510-1511, 1513, and 1515. Hence, the description of the same is not reproduced for the sake of brevity of the description. The process is similar to the one described in FIG. 14, with the only difference being the use of web service as the transmission medium for sharing the broadcast source information. Accordingly, at step 1507, a share via option in enabled in the UI of the user 1 903 device. Accordingly, the user 1 selects the web service, i.e., family account as a transmission medium to share the broadcast source information. At step 1508, the user 1 shares the broadcast source information with the user 2 via the family account. At step 1309, the user 2 opens the family account UI and accepts the request shared by the user 1 via the family account to get the broadcast source information. Further, at steps 1511-1512, the user 3 syncs to the PA similar to steps 1508-1510 after receiving the broadcast source information from the user 2. Similarly, at step 1514, the user 4 syncs to the PA similar to steps 1509-1510 after receiving the broadcast source information from the user 3.

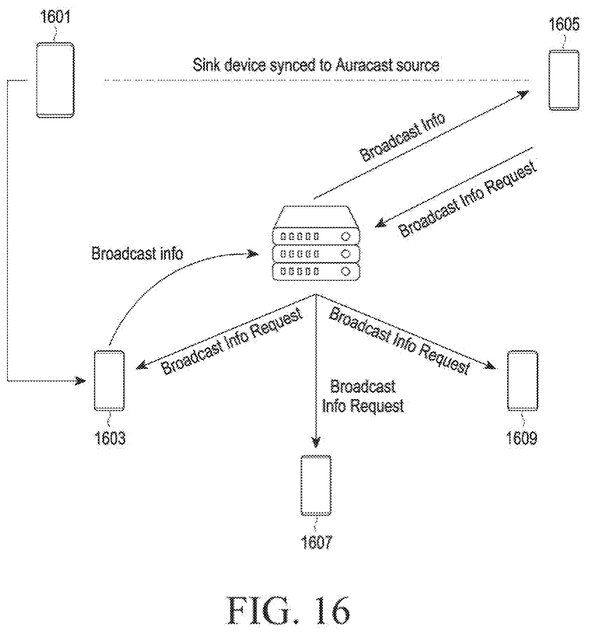

FIG. 16 illustrates a scenario of sharing broadcast source information between broadcast assistant devices using a server, according to one or more embodiments of the present disclosure. As shown in FIG. 16, device 1601 serves as the broadcast source, while device 1603 acts as a broadcast assistant (BA) synchronized with the broadcast source 1601. When device 1605 wants to connect to the broadcast source 1601, device 1605 sends a request to a server 1602. The server 1602 forwards this request to all devices associated with the same family account, devices 1607, and 1609. Since BA 1603 is already synchronized with the broadcast source 1601, BA 1603 provides the necessary information, i.e., the broadcast source information to the server 1602 to allow the device 1605 to sync with the broadcast source 1601. The devices 1607 and 1609 may ignore the request, as the users are not synced to the broadcast source 1601. The server 1602 then relays the broadcast source information from the device 1603 to the device 1605, allowing the device 1605 to successfully sync with the broadcast source 1601.

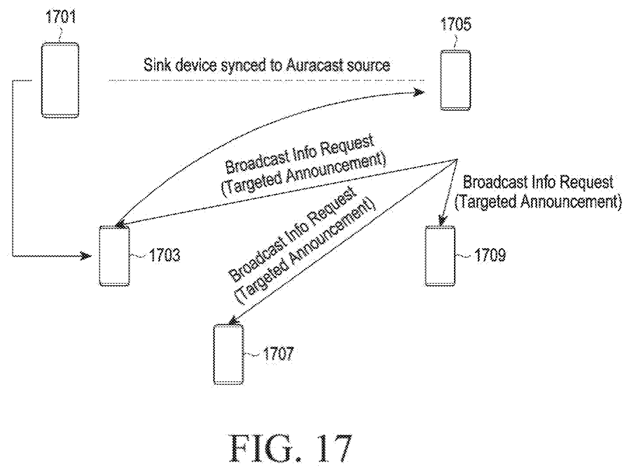

FIG. 17 illustrates a scenario of sharing broadcast source information between broadcast assistant devices using a targeted announcement, according to one or more embodiments of the present disclosure. As shown in FIG. 17, device 1701 serves as the broadcast source, while device 1703 acts as a broadcast assistant (BA) synchronized with the broadcast source 1701. When device 1705 wants to connect to the broadcast source 1701, device 1705 sends a targeted announcement to all the devices, i.e., 1703, 1707, and 1709 logged in with the same family account. All the devices that are in Bluetooth range receive the targeted announcement and decide whether to entertain or ignore the request. Since BA 1703 is already synchronized with the broadcast source 1701, BA 1703 provides the necessary information, i.e., the broadcast source information to the device 1705 to sync with the broadcast source 1701. BA 1703 may establish a wireless communication with the device 1705 to transmit the broadcast source information. The devices 1707 and 1709 may ignore the request, as the users are not synced to the broadcast source 1701. The device 1705 successfully syncs with the broadcast source 1701 based on the received broadcast source information.

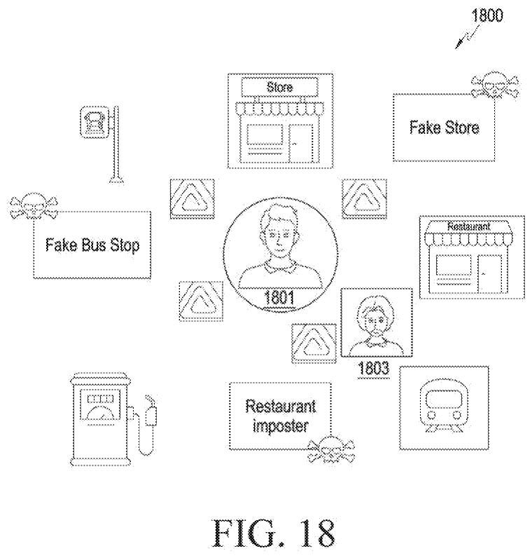

FIG. 18 illustrates an example depicting a reduction in the risk of joining malicious broadcasts, according to one or more embodiments of the present disclosure. As shown in FIG. 18, user 1801 is in a public space with friends, such as user 1803, and is surrounded by multiple LE audio broadcast sources from places like convenience stores, public transport systems, restaurants, and gas stations. While most of these sources may be authentic, some could be fake or imposter sources that mimic legitimate LE audio broadcasts by using the same name and metadata, intending to confuse users. These fake sources may be set up with malicious intent to send harmful data via broadcast isochronous streams. The user 1803 informs the user 1801 to connect to the LE audio broadcast from the bus stop to receive real-time updates. However, without a way to distinguish authentic sources from imposters, the user 1801 risks accidentally connecting to a malicious broadcast from a fake bus stop. To mitigate this risk, when the user 1801 encounters multiple sources with similar names, the users hesitate to select any, fearing the potential dangers of connecting to a fake broadcast. In this scenario, the user 1803, who has already connected to the authentic broadcast, can share the genuine broadcast source information with the user 1801 using any of the methods described in reference to FIGS. 12 to 17. This allows the first user to confidently join the authentic broadcast, reducing the risk of connecting to a malicious source.

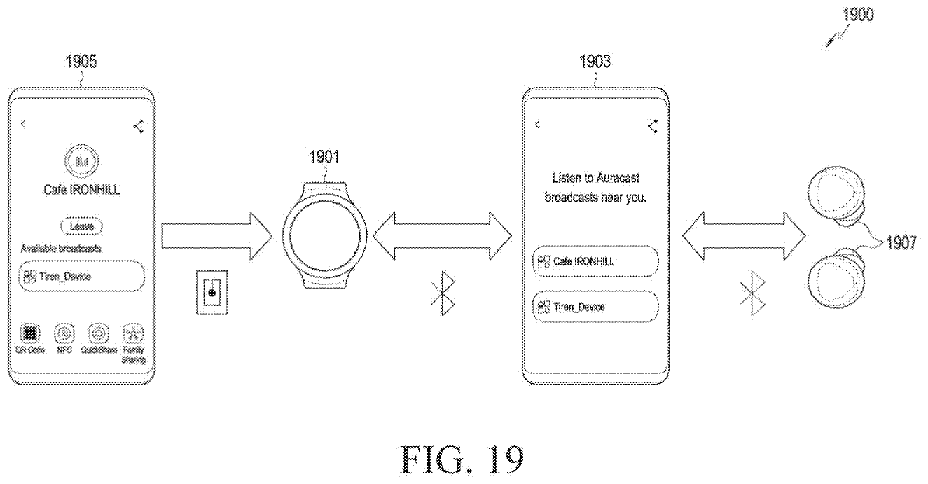

FIG. 19 illustrates a use case scenario 1900 for sharing the broadcast source information between the broadcast assistant devices, according to one or more embodiments disclosed herein. Sharing broadcast source information between a BA1 1901 that does not support broadcast audio scanning/LE audio services and a BA2 1903 that does support these services can be done via Bluetooth (BT) or Bluetooth Low Energy (BLE). An example of a BA1 1901 could be a watch, while the BA2 1903 might be a laptop, smartphone, or TV. The BA1 1901 obtains the broadcast source information through an NFC tap and relays this data to the companion BA2 1903 via the BT/BLE connection. Once the BA2 1903 receives the broadcast source information, it starts scanning for nearby broadcast sources. The BA2 1903 specifically scans for periodic advertisements from the broadcast source 1905 identified by the metadata it received from the BA1 1901 in the broadcast source information, enabling the broadcast sink (BS) 1907 such as, earbuds or headphones connected to the BA2 1903 to join the broadcast session.

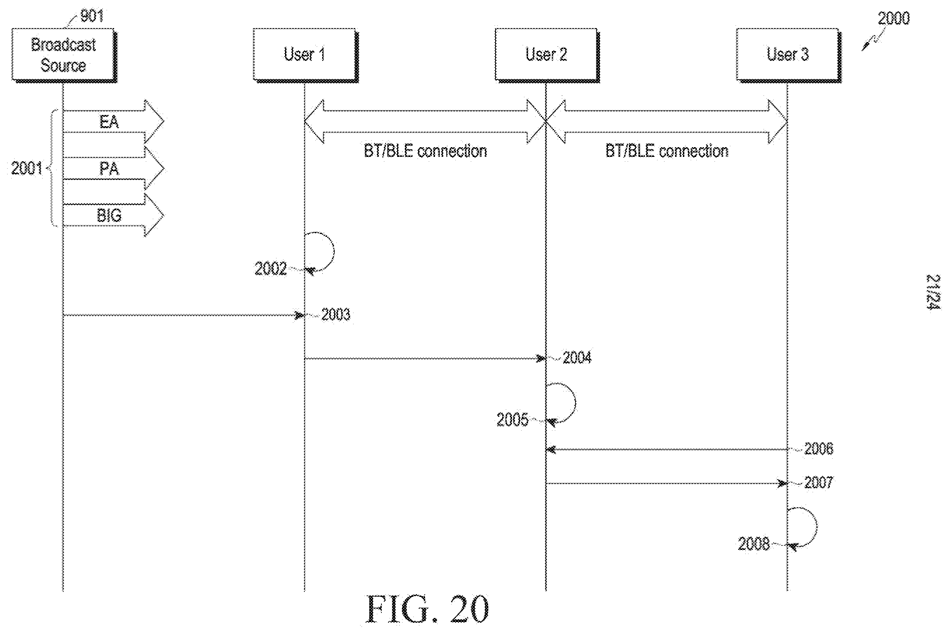

FIG. 20 illustrates a line diagram depicting steps for method 2000 of sharing the broadcast source information between the broadcast assistant devices for the example case scenario of FIG. 19, according to one or more embodiments of the present disclosure. At step 2001, the broadcast source 1905 begins the broadcast session. At step 2002, the BA2 1901 (i.e., the watch) acts as the NFC Reader to get the broadcast source information from the broadcast source 1901. At step 2003, the broadcast source information is shared via the NFC. At step 1904, the BA1 1901 shares the broadcast source information with the BA2 1903 via the BT. At step 2005, the BA2 1903 starts scanning for periodic advertisements of the broadcast source 1901. At step 2006, a synchronization information request is sent from the BS 1907 to the BA2 1903. At step 2007, the PAST information is shared from the BA2 1903 to the BS 1907. At step 1908, the BS 1907 initiates an add source operation and syncs to the PA.

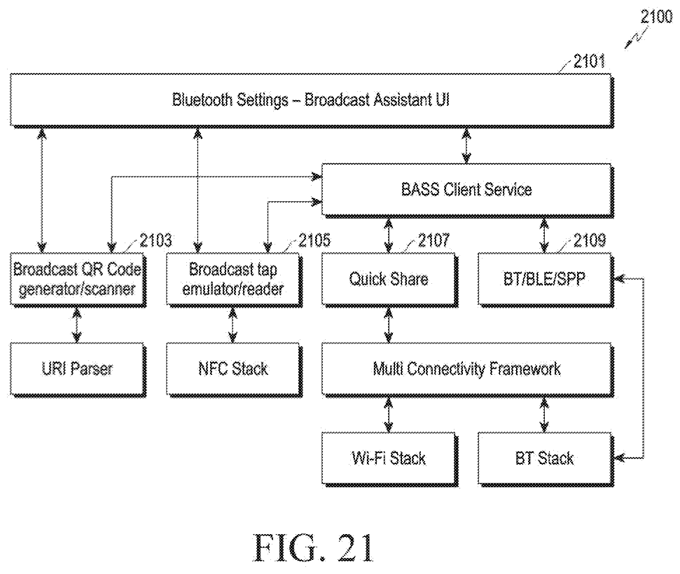

FIG. 21 illustrates an architecture of a system 2100 for sharing the broadcast source information between the broadcast assistant devices, according to one or more embodiments of the present disclosure. The system 2100 may include but is not limited to a Bluetooth settings module 2101 (also referred to as a broadcast assistant UI), a broadcast QR code generator/scanner 2103, a broadcast tap emulator reader 2105, a quick share 2105, and a BT/BLE/SPP 2107 among other components which are known to a person skilled in the art. The broadcast assistant UI element 2101 may be added to the assistant activity. The UI element 2101 may become visible and clickable as soon as the BS connected to the BA has joined the broadcast session. If the BS is no longer listening to the broadcast session, the UI element 2101 may be greyed out and not clickable. Further, the QR code generator 2103 may create the QR code from the Uniform Resource Identifier (URI) for the broadcast source information. The QR code generator 2103 gets the broadcast source information and code from a Broadcast Audio Scan Service (BASS) Client Service. The QR code scanner 2103 scans the QR code using a camera and parses the URI. If the URI contains the BASS identifier, the module 2103 requests the Bass Client service to perform the Add Source operation to join the broadcast session. The module 2103 generates the BASS URI that contains the broadcast source information. Further, the broadcast tap emulator 2105 may create a tap point on the BA for other users to tap their devices. The tap emulator 2105 may generate the broadcast source information and code from the BASS Client Service. The tap reader 2105 may receive the Bass URI through the NFC tap. If the URI contains the BASS identifier, the tap reader 2105 may request the Bass Client service to perform an add source operation to join the broadcast session. The quick share receiver framework 2107 may be modified to parse the BASS URI and show a pop-up request to the user to decide whether to join the broadcast session or ignore it. If the user chooses to join the broadcast session, the quick share framework 2107 may request the Bass Client Service to perform an add source operation. The BT/BLE/SPP framework 2109 may be modified to parse the BASS URI and show a pop-up request to the user to decide whether to join the broadcast session or ignore it. If the user chooses to join the broadcast session, the BT/BLE/SPP framework 2109 may request the Bass Client Service to perform an add source operation.

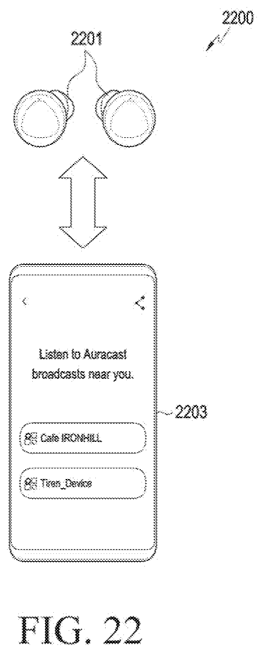

FIG. 22 illustrates an environment for sharing broadcast source information via a button in a broadcast assistant User Interface (UI), according to one or more embodiments of the present disclosure. For example, as shown, a broadcast sink, such as earbuds 2201 are connected to a phone 2203, acting as the broadcast assistant (BA). The earbuds 2201 have been synced to the PA belonging to a broadcast source. The earbuds 2201 may be enabled share via a button in the BA UI. Further, the earbuds 2201 may be disconnected from the BA 2203 by disabling the button. Further, the button may also be abled when the earbuds 2201 lose sync to the PA.

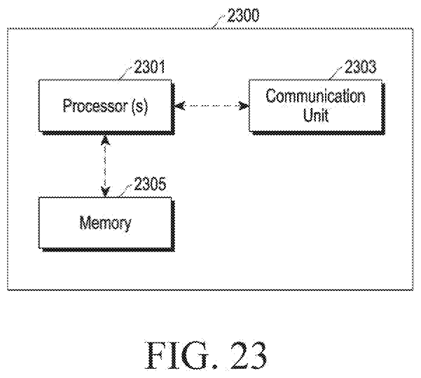

FIG. 23 illustrates a block diagram of a system of sharing broadcast source information during an audio broadcast session, in accordance with an embodiment of the disclosure.

The configuration of FIG. 23 may be understood as a part of the configuration of the sender device 1303. Further, the techniques disclosed above in reference to FIGS. 13 to 24 may be implemented in the system 2300 according to a further embodiment. Non-limiting examples of the system 2300 are an electronic device, a mobile device, and a user equipment.

In an embodiment, the system 2300 corresponds to the sender device 1301. Referring to FIG. 23, the system 2300 may include “processor(s)” which is at least one processor 2301, a communication circuit 2303 (e.g., communicator or communication interface), and a memory 2305.

As an example, the at least one processor 2301 may be a single processor or a number of processors, all of which could include multiple computing circuits. The processor 2301 may be implemented as one or more microprocessors, microcomputers, microcontrollers, digital signal processors, central processing units, state machines, logic circuitries, and/or any devices that manipulate signals based on operational instructions. Among other capabilities, the processor 2301 is configured to fetch and execute computer-readable instructions and data stored in the memory 2305. The processor 2301 may include one or a plurality of processors. At this time, one or a plurality of processors 2301 may be a general-purpose processor, such as a Central Processing Unit (CPU), an Application Processor (AP), or the like, a graphics-only processing unit such as a Graphics Processing Unit (GPU), a Visual Processing Unit (VPU), and/or an AI-dedicated processor such as a Neural Processing Unit (NPU). The one or a plurality of processors 2301 may control the processing of the input data in accordance with a predefined operating rule or Artificial Intelligence (AI) model stored in the non-volatile memory and the volatile memory, i.e., the memory 2305. The predefined operating rule or AI model is provided through training or learning.

The communication circuit 2303 may perform functions for transmitting the broadcast source information via a wireless channel. In an embodiment, the communication circuit 2303 may transmit the broadcast source information to the sender device 1303, in accordance with techniques disclosed in the disclosure. In another embodiment, the at least one processor 2301 may perform operations 1401 to 1405 of FIG. 14 via the communication circuit 2303.

The memory 2305 may include any non-transitory computer-readable medium known in the art including, for example, volatile memory, such as Static Random Access Memory (SRAM) and Dynamic Random Access Memory (DRAM), and/or non-volatile memory, such as Read-Only Memory (ROM), erasable programmable ROM, flash memories, hard disks, optical disks, and magnetic tapes. The memory 2305 may also store the broadcast source information in accordance with techniques disclosed in the disclosure. Further, the memory 2305 may include an operating system for performing one or more tasks of the system 2300, as performed by a generic operating system in the communications domain.

Accordingly, the disclosed techniques provide re-sharing of the broadcast source information between the users (i.e., broadcast assistants).

Accordingly, the disclosure may provide various advantages, such as:

Efficiency: Only one user needs to scan and sync to the broadcast, while the others quickly join through shared information.

Reduced Power Consumption: Sharing the broadcast details directly avoids unnecessary power usage (e.g., repeated scanning and syncing by multiple users).

Eliminates Confusion: The risk of users joining the wrong broadcast or being overwhelmed by multiple broadcast options with similar names is eliminated.

Improved User Experience: The process is simplified, saving time and making it easier for groups to join the same broadcast seamlessly.

Enhanced Security: As the users connect to the correct broadcast source using the disclosed techniques, the risk of connecting to a malicious broadcast source is reduced. Since the malicious/harmful broadcast tries to imitate the same name as the original broadcast source, the disclosed techniques prevent users from connecting to such broadcast sources.

Accordingly, the disclosed technique significantly enhances the user experience in LE audio broadcast environments by allowing users to share broadcast source information efficiently. The disclosed technique minimizes confusion, reduces power consumption, and saves time by eliminating the need for each user to scan and sync individually. The disclosed technique is particularly useful in public spaces, cafes, or events where multiple users want to connect to the same broadcast without the hassle of repeated steps.

In this application, unless specifically stated otherwise, the use of the singular includes the plural, and the use of “or” means “and/or.” Furthermore, the use of the terms “including” or “having” is not limiting. Any range described herein will be understood to include the endpoints and all values between the endpoints. Features of the disclosed embodiments may be combined, rearranged, omitted, etc., within the scope of the invention to produce additional embodiments. Furthermore, certain features may sometimes be used to advantage without a corresponding use of other features.

While example embodiments have been presented in the foregoing detailed description, it should be appreciated that many variations exist.

What is claimed is:

1. A method for sharing broadcast source information, the method comprising:
determining, by a sender device, whether broadcast source information associated with an audio broadcast session is to be shared with at least one receiver device based on a user input from a user of the sender device and a request from the at least one receiver device;
based on determining that the broadcast source information is to be shared with the at least one receiver device, selecting, by the sender device, a transmission medium from among a plurality of transmission mediums for sharing the broadcast source information; and
transmitting, by the sender device, at least one data packet over the transmission medium, the at least one data packet comprising the broadcast source information.

2. The method of claim 1, wherein the selecting the transmission medium comprises:
receiving, at the sender device, one of:
a user-selection input from the user of the sender device to use the transmission medium from among the plurality of transmission mediums, or
a request message, from the at least one receiver device, to use the transmission medium from among the plurality of transmission mediums; and
selecting, by the sender device, the transmission medium based on the one of the user-selection input or the request message.

3. The method of claim 1, wherein the plurality of transmission mediums comprises at least one of a Bluetooth, a Bluetooth Low Energy (BLE), a Wi-Fi, a Near Field Communication (NFC), a nearby share, web based sharing, a Quick Response (QR) code, or an out of band (OOB) communication.

4. The method of claim 1, wherein the broadcast source information comprises at least one of a broadcast source identification (ID), a name of a broadcast source, a broadcast code, metadata related to broadcast content, an address of the broadcast source, or an address type of the address of the broadcast source.

5. The method of claim 1, wherein the sender device and the at least one receiver device are part of a connected network.

6. A device comprising:
memory storing instructions; and
at least one processor,
wherein the instructions, when executed by the at least one processor individually or collectively, cause the device to:
determine whether broadcast source information associated with an audio broadcast session is to be shared with at least one receiver device based on a user input from a user of a sender device and a request from the at least one receiver device;
based on determining that the broadcast source information is to be shared with the at least one receiver device, select a transmission medium from among a plurality of transmission mediums for sharing the broadcast source information; and
transmit at least one data packet over the transmission medium, the at least one data packet comprising the broadcast source information.

7. The device of claim 6, wherein to select the transmission medium, the instructions, when executed by the at least one processor individually or collectively, cause the device to:
receive one of:
a user-selection input from the user of the sender device to use the transmission medium from among the plurality of transmission mediums, or
a request message, from the at least one receiver device, to use the transmission medium from among the plurality of transmission mediums; and
select the transmission medium based on the one of the user-selection input or the request message.

8. The device of claim 6, wherein the plurality of transmission mediums comprises at least one of a Bluetooth, a Bluetooth Low Energy (BLE), a Wi-Fi, a Near Field Communication (NFC), a nearby share, web based sharing, a Quick Response (QR) code, or an out of band (OOB) communication.

9. The device of claim 6, wherein the broadcast source information comprises at least one of a broadcast source identification (ID), a name of a broadcast source, a broadcast code, metadata related to broadcast content, an address of the broadcast source, or an address type of the address of the broadcast source.

10. The device of claim 6, wherein the sender device and the at least one receiver device are part of a connected network.

11. A non-transitory computer-readable recording medium storing instructions that are executed by at least one processor to perform a method for sharing broadcast source information, the method comprising:
determining, by a sender device, whether broadcast source information associated with an audio broadcast session is to be shared with at least one receiver device based on a user input from a user of the sender device and a request from the at least one receiver device;
based on determining that the broadcast source information is to be shared with the at least one receiver device, selecting, by the sender device, a transmission medium from among a plurality of transmission mediums for sharing the broadcast source information; and
transmitting, by the sender device, at least one data packet over the transmission medium, the at least one data packet comprising the broadcast source information.

12. The non-transitory computer-readable recording medium of claim 11, wherein the selecting the transmission medium comprises:
receiving, at the sender device, one of:
a user-selection input from the user of the sender device to use the transmission medium from among the plurality of transmission mediums, or
a request message, from the at least one receiver device, to use the transmission medium from among the plurality of transmission mediums; and
selecting, by the sender device, the transmission medium based on the one of the user-selection input or the request message.

13. The non-transitory computer-readable recording medium of claim 11, wherein the plurality of transmission mediums comprises at least one of a Bluetooth, a Bluetooth Low Energy (BLE), a Wi-Fi, a Near Field Communication (NFC), a nearby share, web based sharing, a Quick Response (QR) code, or an out of band (OOB) communication.

14. The non-transitory computer-readable recording medium of claim 11, wherein the broadcast source information comprises at least one of a broadcast source identification (ID), a name of a broadcast source, a broadcast code, metadata related to broadcast content, an address of the broadcast source, or an address type of the address of the broadcast source.

15. The non-transitory computer-readable recording medium of claim 11, wherein the sender device and the at least one receiver device are part of a connected network.
